(19) United States
(12) Patent Application Publication
(10) Pub. No.: US 2007/0072593 A1
(43) Pub. Date: Mar. 29, 2007

(54) Call prioritizing systems and methods

(76) Inventor: Virupakshaiah Huliyapur Math, Basaweshwara Nagar (IN)

Correspondence Address: KYOCERA WIRELESS CORP., P.O. BOX 928289, SAN DIEGO, CA, 92192-8289, US

(21) Appl. No.: 11/228,865

(22) Filed: Sep. 16, 2005

(51) Int. Cl. H04M 3/42

(52) U.S. Cl. 455/415

(57) ABSTRACT

Systems and methods allow a mobile wireless communication device user to designate a priority level of the contacts in a contact list. During an existing call, incoming higher priority calls can be handled differently than lower priority calls. For example, higher priority calls can be automatically answered, without any need to review the contact. Lower priority call can be automatically sent directly to an answering service, instead of interrupting an existing higher priority call.

### BACKGROUND OF THE INVENTION

1. Field of the Invention

The invention relates generally to wireless communications and more particularly to systems and methods for prioritization of calls in wireless communications.

2. Background

Portable communication devices are rapidly becoming ubiquitous. Portable telephones such as cell phones and satellite phones, wireless enabled personal digital assistants (PDA's), pagers, and wireless enabled portable computing devices such as laptop computers are example portable communications devices. Cell phones with integrated cameras (still and video) are another example.

Commonly, a cell phone user is in an existing call when an incoming call is received. The commonly known “call waiting” alert (usually a short, single tone sound) is typically played to the user. The “call waiting” alert typically interrupts the existing call briefly. The identity of the incoming caller (whether number identity or name identity) is typically displayed on a display screen for the user. If the user wishes to know who is calling, the user must typically stop the existing conversation briefly to observe the display screen and decide whether to further interrupt the existing call by answering the incoming call.

There is no automatic prioritization among callers in cellular communication. A cell phone user cannot know automatically whether an incoming caller has a higher or lower priority than the present conversation. Thus, a cell phone user typically has to interrupt his or her conversation when a new call is incoming. Further the cell phone user must have memorized the priority level of all of his or her contacts. Still further, the cell phone user may be commonly interrupted by lower priority calls, with, for example, a call waiting tone, when the user would prefer to ignore lower priority calls. Still further, the cell phone user may miss higher priority calls, if the cell phone user inadvertently treats a high priority incoming call like a low priority incoming call and ignores the call waiting tone.

### SUMMARY OF THE INVENTION

In order to overcome the problems associated with conventional approaches for handling incoming calls during existing calls systems and methods are provided that allow a mobile wireless communication device user to designate a priority level of the contacts in a contact list. During an existing call, incoming higher priority calls can be handled differently than lower priority calls. For example, higher priority calls can be automatically answered, without any need to review the contact. Lower priority call can be automatically sent directly to an answering service, instead of interrupting an existing higher priority call.

Advantageously, higher priority calls are missed less often. And lower priority calls no longer interrupt higher priority calls.

Other aspects, advantages, and novel features of the invention will become apparent from the following Detailed Description, when considered in conjunction with the accompanying drawings.

### BRIEF DESCRIPTION OF THE DRAWINGS

Preferred embodiments of the present inventions taught herein are illustrated by way of example, and not by way of limitation, in the figures of the accompanying drawings, in which:

FIG. 1 is a table representation of a phone book database.

FIG. 2 is a table representation of a voice database.

FIG. 3 is a table representation of a priority list.

FIG. 4 is a block diagram illustrating three mobile communication devices showing an incoming call during an existing call.

FIG. 5 is a block diagram illustrating a mobile communication device.

FIG. 6 is a flow chart illustrating receiving an incoming call during an existing call.

### DETAILED DESCRIPTION

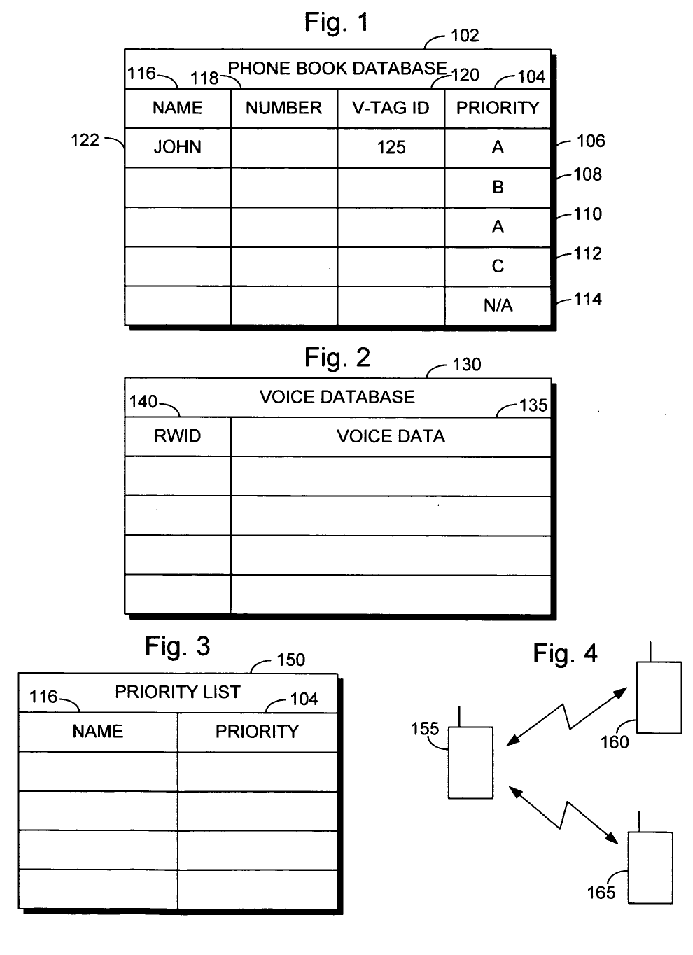

FIG. 1 is a table representation of phone book database 102 for storing contact information in a mobile communication device. Advantageously, phone book database 102 has priority column 104. Priority column 104 can store priorities 106, 108, etc. for each of the entries in phone book database 102. For example, the mobile communication device may be a cell phone. Hereinafter, cell phone will be used to refer to a mobile communication device, for convenience of illustration. However, any mobile communication device could be used.

Phone book database 102 stores names 116 of the contacts. A number 118 (typically phone number) is stored for each contact. Phone book database 102 also stores voice tag identifications (V-tag ID's) 120. V-tag ID's are tags, or internal identifiers, for audio files associated with each contact. For example, the user of the cell phone may record the contact's name in the user's own voice. For example, if the first contact's name is John 122, the user may record “John” for the first contact. Then V-tag ID 125 is an internal flag designating the voice (audio) file with the recorded sound “John”. Thus, phone book database 102 stores names 116, numbers 118, V-tag ID's 120 and priorities 104.

The actual audio files recorded (e.g., the sound, “John”) are stored in another database, voice database 130, which is illustrated in FIG. 2. Voice database 130 stores voice data 135 (audio files), along with the appropriate the internal tags 140 for identifying the voice data. The internal tags may be any convenient type. For example, the internal tags may be recognizable word identifiers (RWID). In fact, the same internal tag may be referred to as an RWID or a V-tag ID. Thus, the V-tag ID 120 in phone book database 102 may be used as a RWID 140 in voice database 130. Voice database 130 may also be used to store voice prompts such as “say a name”, voice memos and such. The voice audio files are not necessarily associated with particular contacts and need not be described further here.

FIG. 3 is a table representation of priority list 150. Priority list 150 shows just the names 116 and the priorities 104 from phone book database 102. The user can set and review priorities in phone book database 102 using priority list 150. For example, a user interface software on a cell phone displays priority list (or a portion thereof) to the user. The user can select a contact by name 116 and then change or add a priority 104. Optionally, the user could also select and change priorities 104 from the users contact list. The contact list is a list displayed to the user containing at least the names 116 and number 118 of the user's contacts. The contact list may also include priorities 104. If the contact list includes priorities 104, then priority list 150 would not be needed, though it still might be available.

FIG. 4 is a block diagram illustrating three mobile communication devices showing an incoming call during an existing call. Advantageously, the priorities of the existing caller and the incoming caller are automatically compared and the cell phone handles the incoming call appropriately. Cell Phone A 155 is in a call with Cell Phone B 160. Cell Phone B 160 could actually be any call terminal such as a plane old telephone service (POTS) telephone. For simplicity, the network equipment connecting Cell Phone A 155 to a wireless network and to the public switched telephone network (PSTN) are not shown. Also, the equipment connecting Cell Phone B 160 to the wireless network is not shown. Some aspects of wireless networks are described in U.S. patent application Ser. No. 10/903,174, filed on Jul. 30, 2004; and Ser. No. 11/125,517 filed on May 9, 2005, which are incorporated herein by reference.

While Cell Phone A 155 is in a call with Cell Phone B 160, Cell Phone A receives an incoming call indicator from Cell Phone C 165. Cell Phone C 165, similar to Cell Phone B 160, may actually be any device capable of initiating a call to Cell Phone A. The incoming call indicator may be an incoming call message, as described in the above-referenced U.S. patent application Ser. No. 10/903,174, or any convenient type of incoming call indicator. Typically, the incoming call indicator has a caller identifier identifying the Cell Phone C 165, such as a telephone number. Alternatively, Cell Phone A 150 will receive a caller identifier after receiving the incoming call indicator.

When Cell Phone A 155 receives the caller identifier, such as a phone number, Cell Phone A 155 looks up the caller identifier in Cell Phone A's 155 phone book database 102, to see if the caller identifier is listed (either as a name 116 or a number 118) among Cell Phone A's 155 contact information. If Cell Phone A 155 finds a match, then Cell Phone A 155 retrieves the priority (if any) associated with the caller identifier. Cell Phone C's 165 priority is referred to as the retrieved priority or the incoming caller priority. If no match is found for Cell Phone C 165 in Cell Phone A's 155 phone book database 102, then Cell Phone A 155 may designate Cell Phone C's priority as the lowest priority. As shown in phone book database 102, priority A 106 and 110 are the highest priority, priority B 108 is a middle priority, priority C 112 is the lowest priority, and N/A 114 indicates that no priority is designated. As stated above, no priority designated 114 may be considered lower than the lowest priority C 112. Thus, effectively, there would be four priority levels, A, B, C, and none, with C being the second lowest priority and none actually being the lowest priority.

Cell Phone A 155 also looks up the priority of the user of Cell Phone B 160, which is referred to as the existing priority since Cell Phone A 155 is in an existing call with Cell Phone B 160. Cell Phone A 155 may have looked up and stored Cell Phone B's 160 priority when the call with Cell Phone B started. If no priority for Cell Phone B 160 is available in Cell Phone A's 155 phone book database 102, then Cell Phone A may designate Cell Phone B 160 as having the lowest priority. Cell Phone A compares the retrieved priority to the existing priority of the user of Cell Phone B. Cell Phone A determines whether the incoming caller priority is higher than the existing caller priority. Cell Phone A handles the incoming call in a way that is responsive to the determination.

For example, if Cell Phone A 155 determines that the incoming caller priority is higher than the existing priority, then Cell Phone A 155 will automatically connect the incoming call (from Cell Phone C 165 as shown), or at least will play a call waiting alert to the user of Cell Phone A. If Cell Phone A 155 determines that the incoming caller priority is lower than the existing priority, then Cell Phone A 155 does not interrupt the existing call (with Cell Phone B 160 as shown), or at most plays a call waiting alert. If Cell Phone A 155 determines that the incoming caller priority and the existing priority are the same, then optionally, the existing call is not interrupted. But, optionally, if the incoming caller priority and the existing priority are the same, the incoming call is connected. As still another option, if the incoming caller priority and the existing priority are the same, then Cell Phone A 155 may cause a call waiting alert to be played to the user. Primarily, the response of Cell Phone A 155 to the incoming call indicator is different depending upon the relative priorities of the existing call and the incoming call.

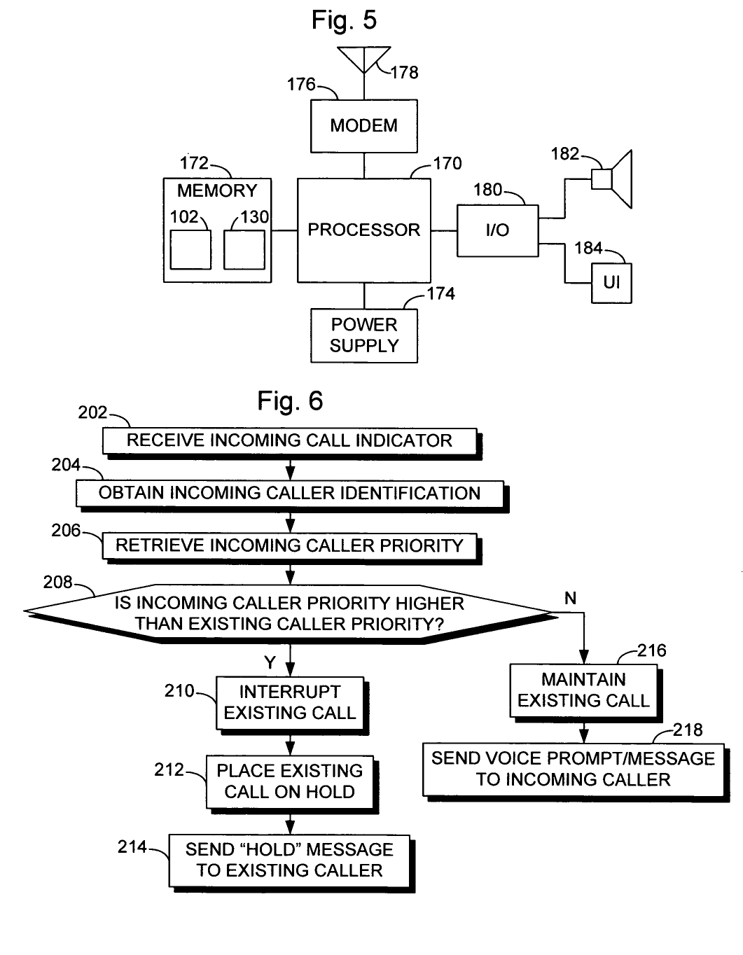

FIG. 5 is a block diagram illustrating a mobile communication device (such as, for example, Cell Phone A 155) for handling an incoming call differently depending upon the relative priorities of an existing call and the incoming call. Processor 170 provides control functions for the Cell Phone A 155. Processor 170 controls the user interfaces (described below) and over-the-air communications. Processor 170 is connected to memory 172. Memory 172 stores phone book database 102 and voice database 130. Thus, the references above generally describing Cell Phone A 155 looking up priorities 104 refer to processor 170 looking up priorities in the database 102 stored in memory 172.

Processor 170 is connected to mobile power supply 174, for providing power to processor 170. Power supply 174 is typically a battery. However, it may be possible in the future to power mobile wireless communication devices by other mobile power supplies, such as fuel cells or solar power transducers. Any practical power supply is possible.

Processor 170 is also connected to modem 176. Modem stands for modulator/demodulator. Modem 176 modulates and demodulates signals, such as voice signals, to be transmitted and that are received over-the-air. For example, modem 176 may be a code division multiple access (CDMA) modem complying with IS-2000. TIA/EIA IS-2000. As another example, modem 176 may be a global system for mobile communication (GSM) modem complying with one of the GSM standards produced by the 3^{rd} Generation Partnership Project (3GPP), Sophia-Antipolis, France. Any convenient type of modem may be used. Further, the distinction between a base band modem and a radio frequency or intermediate frequency modem is not made here. The primary point is that modulated signals are sent over-the-air. Modem 176 may even be incorporated in part (and possibly in the future completely) with processor 170. Modem 176 is connected to antenna 178, which transmits signals over-the-air and receives signals over-the-air.

Processor 170 is also connected to input/output (IO) interface 180. IO interface 180 interfaces processor to the various user interface (UI) devices available to processor 170. One UI device is speaker 182. Speaker 182 is used to play the call waiting alerts to the user described above. Also, speaker 182 transmits audio signals (sound, such as voice) to the user's ear. Other UI devices 184 are shown as general UI device 184. Other UI devices 184 include a microphone, a display screen and a keypad (all not individually shown).

FIG. 6 is a flow chart illustrating a method for handling an incoming call during an existing call differently depending upon whether the incoming caller priority is higher than the existing caller priority or not. The method starts at step 202, in which an incoming call indicator is received. It is assumed that an existing call is already in progress. For simplicity, the flow chart starts when the incoming call indicator is received. In step 204, the incoming caller's identification is obtained. In step 206, the incoming caller's priority is retrieved. If the identification cannot be obtained, then it can be assumed that no priority is available and the retrieved incoming caller priority can be assumed to be the lowest priority. Further, even if the incoming caller's identification can be obtained, but no priority is designated, it can be assumed that the retrieved incoming caller priority is the lowest priority.

In step 208, it is determined whether the incoming caller priority is higher than the existing caller priority. If in step 208, it is determined that the incoming caller's priority is higher than the existing caller's priority, then the existing call is interrupted, as shown in step 210. A call switching alert is made at Cell Phone A 155. The call switching alert may be an audio tone, or an audio message may be played to the user of Cell Phone A 155 to notify the user of Cell Phone A 155 that a new call is being connected. The audio message may say, “Connecting to” the particular contact. For example, the audio message may be “Connecting to John”, if John is the contact corresponding to the higher priority call. The portion of the message “Connecting to” may be a particular audio file stored in voice database 130. The portion of the message “John” may be another audio file stored in voice database 130.

In step 212 the existing call is placed on hold. In step 214, a hold message is sent to the existing caller. For example, the hold message might be a prerecorded message by the user of Cell Phone A 155 saying, “Please hold. I have an urgent call that I must take. If you cannot hold, please hang up. I will call you back as soon as possible.”

If the incoming caller priority is not higher than the existing caller priority, then the existing call is maintained, as shown in step 216. If the incoming caller priority is the same as the existing caller priority, then Cell Phone A 155 may play a call waiting alert. In step 218, the incoming caller is sent a voice mail message or a voice prompt. The voice mail message may be sent by the network or by Cell Phone A 155. Either way, the incoming caller is transferred to voice mail.

FIG. 6 could be modified by removing steps 212 and 214. In that case, step 210, interrupting the existing call, would merely be playing a call waiting alert. In this case, the incoming call would still be handled differently depending on the relative priorities of the incoming caller and the existing caller. Instead of playing a call waiting alert for all incoming calls during an existing call, the call waiting alert would only be played for higher priority calls.

Alternatively, FIG. 6 could be modified by removing step 218. In that case, in step 216, the existing call would be maintained, but a call waiting alert would be played. In this case, the incoming call would still be handled differently depending on the relative priorities of the incoming caller and the existing caller. Instead of playing a call waiting alert for all incoming calls during an existing call, the call waiting alert would only be played for lower (or equal) priority calls and higher priority calls would be automatically connected.

Further, while embodiments and implementations of the invention have been shown and described, it should be apparent that many more embodiments and implementations are within the scope of the invention. Accordingly, the invention is not to be restricted, except in light of the claims and their equivalents.

What is claimed is:

1. A method for screening an incoming call during an existing call in a cellular communication system, the method comprising:
(a) receiving an incoming call indicator;
(b) obtaining an incoming caller identification;
(c) retrieving an incoming caller priority based on the incoming caller identification;
(d) determining whether the incoming caller priority is higher than an existing caller priority; and
(e) handling the incoming call in a way that is responsive to a determination that is made in step (d).

2. The method of claim 1, wherein step (e) further comprises:
(f) interrupting an existing call, responsive to step (d).

3. The method of claim 1, further comprising:
(g) playing an audio message corresponding to the incoming caller identification on a cellular communication handset that received the incoming call indicator in step (a).

4. The method of claim 1, further comprising:
(h) sending an interrupt call audio message to a caller corresponding to the existing call.

5. The method of claim 1, wherein step (c) further comprises:
(i) noting that the existing caller priority was not preselected.

6. The method of claim 4, wherein step (c) further comprises:
(j) allocating a low priority to the existing caller priority, responsive to step (i).

7. The method of claim 1, further comprising:
(k) placing the existing call on hold, responsive to step (d).

8. The method of claim 1, wherein step (e) further comprises:
(l) continuing an existing call, responsive to step (d).

9. The method of claim 8, further comprising: (m) sending a not connecting audio message to a caller corresponding to the incoming call.

10. The method of claim 8, wherein step (c) further comprises:
(n) noting that the incoming caller priority was not preselected.

11. The method of claim 10, wherein step (c) further comprises:
(o) allocating a low priority to the incoming caller priority, responsive to step (n).

12. A mobile wireless communication device comprising:
a modem;
a processor connected to the modem and configured to receive an incoming call indicator; obtain an incoming caller identification; retrieve an incoming caller priority based on the incoming caller identification; make a determination whether the incoming caller priority is higher than an existing caller priority; and interrupt an existing call, responsive to the determination; and
a memory connected to the processor, the memory storing a priority list, the priority list comprising the incoming caller priority.

13. The mobile wireless communication device of claim 12, further comprising:
a speaker connected to the processor and wherein the processor is further configured to play on the speaker an audio message corresponding to the incoming caller identification.

14. The mobile wireless communication device of claim 12, wherein the processor is further configured to send, via the modem, an interrupt call audio message to a caller corresponding to the existing call.

15. The mobile wireless communication device of claim 12, wherein the processor is further configured to note that the existing caller priority was not preselected.

16. The mobile wireless communication device of claim 15, wherein the processor is further configured to allocate a low priority to the existing caller priority if the existing caller priority was not preselected.

17. The mobile wireless communication device of claim 12, wherein the processor is further configured to place the existing call on hold.
